(19) United States
(12) Patent Application Publication
(10) Pub. No.: US 2006/0228939 A1
(43) Pub. Date: Oct. 12, 2006

(54) Portable device having rotatable protrusion

(76) Inventor: Shun-Lung Wang, Taipei (TW)

Correspondence Address: RABIN & Berdo, PC, 1101 14TH STREET, NW, SUITE 500, WASHINGTON, DC, 20005, US

(21) Appl. No.: 11/378,390

(22) Filed: Mar. 20, 2006

(30) Foreign Application Priority Data
Apr. 11, 2005 (TW) 94111378

(51) Int. Cl. H01R 13/60

(52) U.S. Cl. 439/529

(57) ABSTRACT

A portable device including a housing and a protrusion is provided. The protrusion includes a first protruding portion, a second protruding portion and a connecting portion. The first protruding portion is pivotally connected to the housing. The first protruding portion rotates with respect to the housing. The second protruding portion is pivotally connected to the housing. The second protruding portion rotates with respect to the housing. A gap exists between the connecting portion and the housing. The connecting portion connects the first and second protruding portions. When the first and second protruding portions rotate with respect to the housing, the first and second protruding portions are modulated to form a variable angle with the housing.

This application claims the benefit of Taiwan application Serial No. 094111378, filed Apr. 11, 2005, the subject matter of which is incorporated herein by reference.

### BACKGROUND OF THE INVENTION

1. Field of the Invention

The invention relates in general to a portable device, and more particularly to a portable device having a rotatable protrusion.

2. Description of the Related Art

Along with the advance in technology, wireless technology such as mobile phone, ipod and PDA has become a necessity in people's everyday life. A lot of mobile phones have a hook, allowing the user to tie a hanging decoration to the hook. Conventional hook may be a through hole disposed on the housing, and the through hole is used as a reeving and hanging space. However, the through hole disposed within the housing is normally very narrow and allows only one hanging decoration suspend from the mobile phone. Moreover, a hook structure allowing more than one hanging decoration to be jointed to for mobile phone is provided. The hook structure is mounted on the mobile phone housing and formed in one-piece molding with the mobile phone housing. The hook is used as a reeving and hanging space for hanging decorations.

However, the conventional hook in one-piece molding with the mobile phone housing is too large, not only the appearance of the device is jeopardized, but the integral size of the mobile phone is also increased. Therefore, the reeving and hanging problem can not be resolved by increasing the size of hook blindly.

### SUMMARY OF THE INVENTION

The invention provides a portable device whose protrusion is pivotally connected to the housing. A larger hanging space of the protrusion allowing the user to hang various sized hanging decorations for mobile phone is created. Besides, when mobile phone is placed on the desk, protrusion is rotated to the rear surface of the housing to brace the device, facilitating the user to view the display screen.

The embodiment of the invention provides a portable device including a housing and a protrusion. The protrusion includes a first protruding portion, a second protruding portion and a connecting portion. The first protruding portion is pivotally connected to the housing. The first protruding portion rotates with respect to the housing. The second protruding portion is pivotally connected to the housing. The second protruding portion rotates with respect to the housing. The connecting portion connects the first protruding portion and the second protruding portion and a gap exists between the connecting portion and the housing. When the first protruding portion and the second protruding portion rotate with respect to the housing, the first protruding portion and the second protruding portion are modulated to form a variable angle with the housing.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a three-dimensional diagram of a portable device according to a preferred embodiment of the invention;

FIG. 1B is a rear view of according to the portable device in FIG. 1A;

FIG. 2A is a side view of the protrusion of the portable device in FIG. 1A under normal circumstances;

FIG. 2B is a side view of the protrusion of the portable device in FIG. 1A after being rotated for 45°;

FIG. 2C is a side view of the protrusion of the portable device in FIG. 1 A after being rotated for 90°; and

FIG. 3 is a side view of the protrusion of the portable device in FIG. 1A placed on a desk after rotation.

### DETAILED DESCRIPTION OF THE INVENTION

The invention creates a larger operating space between a rotatable protrusion and the housing. The invention is exemplified by a preferred embodiment, which is mere an embodiment according to the concept of the invention, and the scope of protection of the invention is not limited thereto.

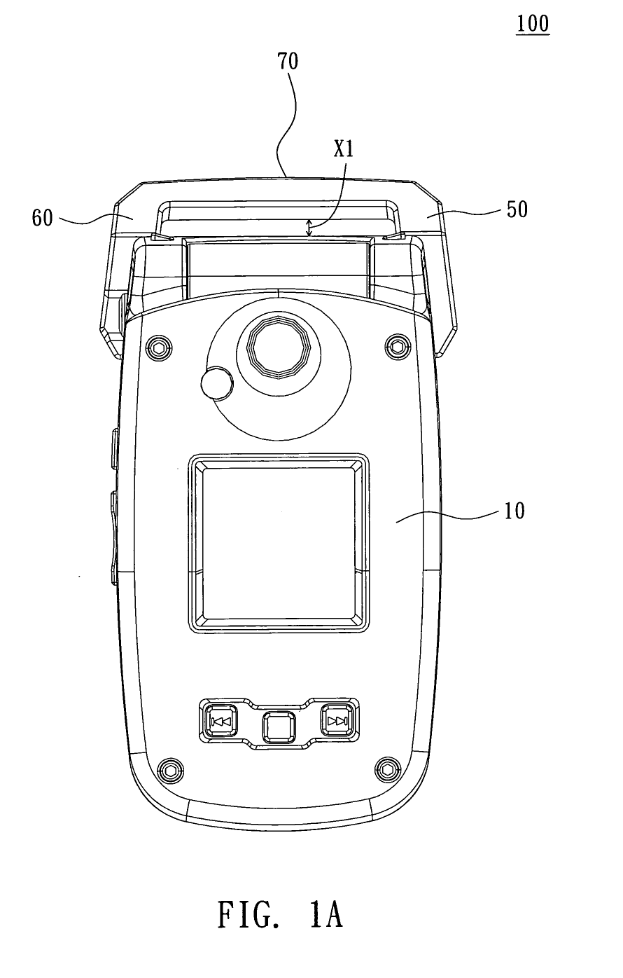

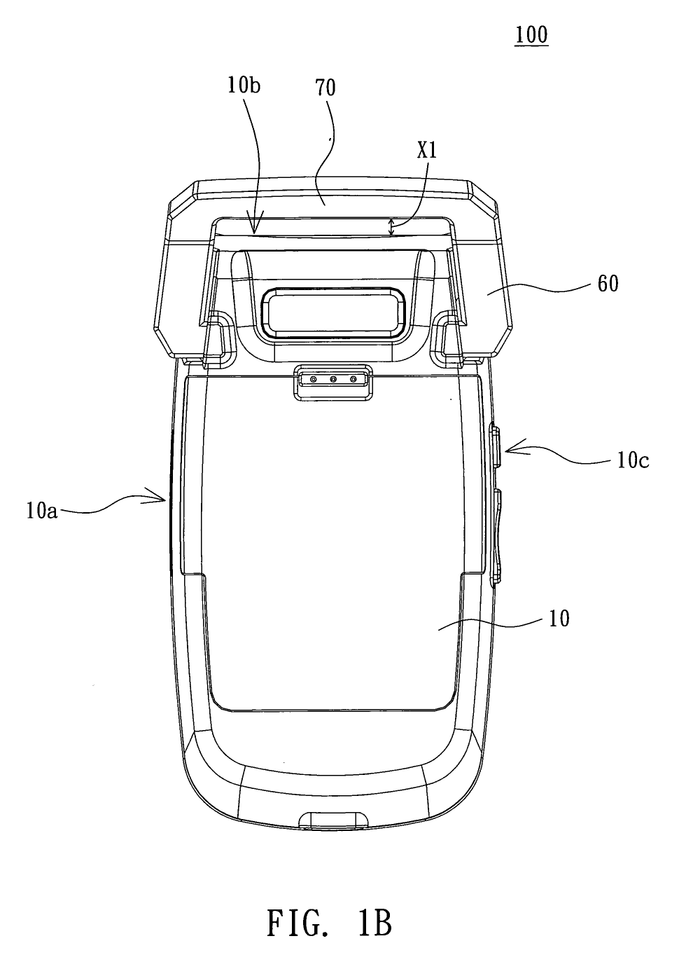

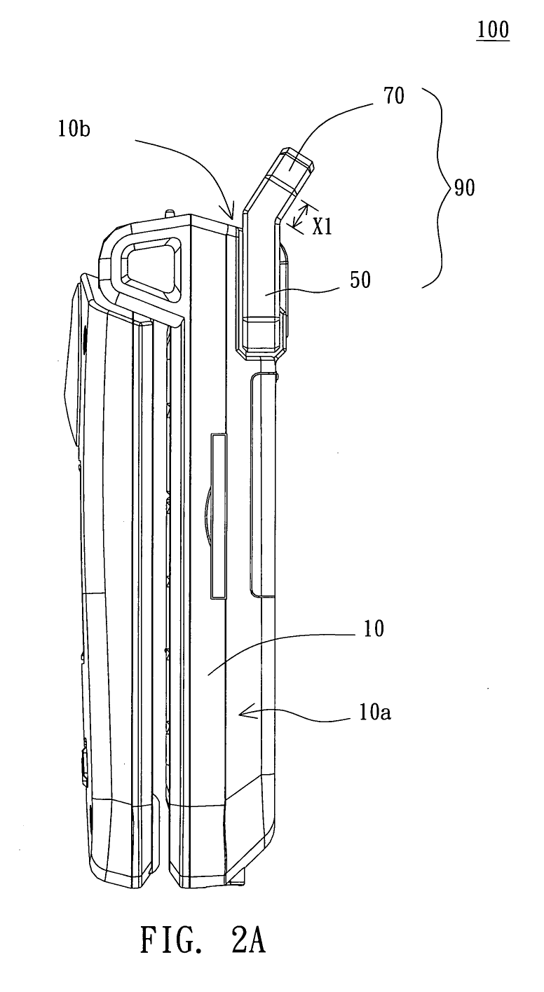

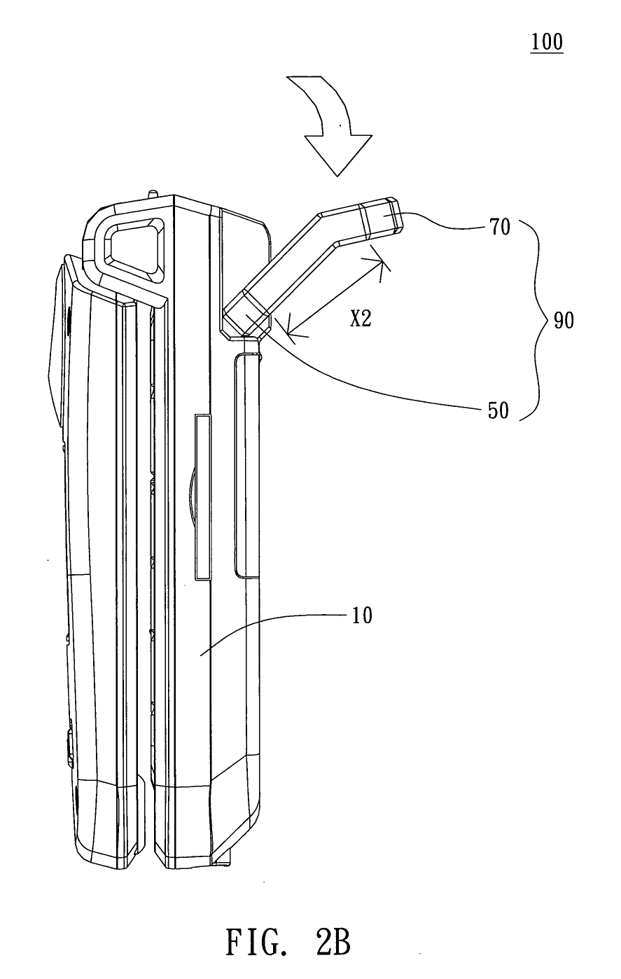

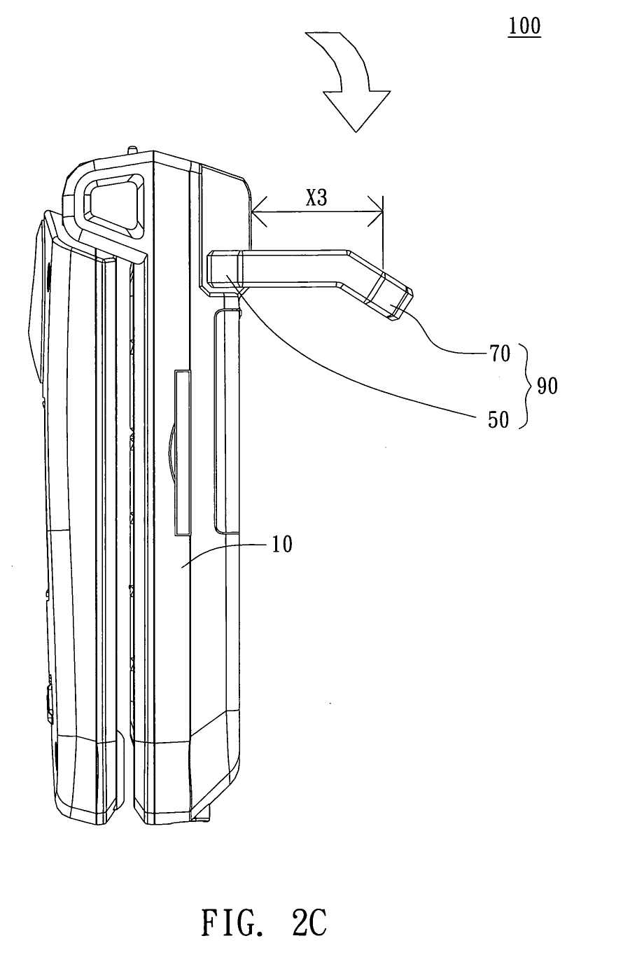

Referring to FIG. 1A, a three-dimensional diagram of a portable device illustrates a preferred embodiment of the invention. Portable device 100 of the present embodiment includes a housing 10 and a protrusion (such as a component labeled 90 in FIG. 2A). The protrusion includes a first protruding portion 50, a second protruding portion 60 and a connecting portion 70. One end of the first protruding portion 50 is pivotally connected to the housing 10, another end is projected from the housing 10. The first protruding portion 50 rotates with respect to the housing 10. One end of the second protruding portion 60 is pivotally connected to the housing 10, and another end is projected from the housing 10. The second protruding portion 60 rotates with respect to the housing 10. A first gap X1 exists between the connecting portion 70 and the housing 10. The connecting portion connects the first protruding portion 50 and the second protruding portion 60. The protrusion is preferred to be substantially U-shaped. Preferably, the first protruding portion 50, the second protruding portion 60 and the connecting portion 70 are formed in one-piece molding. When the first protruding portion 50 and the second protruding portion 60 rotate with respect to the housing 10, the first protruding portion 50 and the second protruding portion 60 are modulated to form a specific angle with the housing 10.

The portable device can be a mobile phone for instance. Preferably, the portable device further includes an antenna module disposed inside the protrusion. Thus, the antenna module of mobile phone does not have to be of a column structure. The protrusion of the embodiment not only has the antenna function, but also can be used for a hanging decoration for mobile phone to be tied to. Besides, the antenna module of mobile phone of the embodiment can be concealed inside the housing or the protrusion, further enhancing the versatility of integral design of the device.

FIG. 1B is a rear view of according to the portable device in FIG. 1A. Referring to FIG. 1B, the first protruding portion 50 is disposed at a lateral surface of 10a of the housing 10, part of the first protruding portion 50 is in close proximity a lateral surface 10a of the housing 10, and another part of the first protruding portion 50 is extended to the edge of the lateral surface 10a of the housing 10 and projected from the top surface 10b of the housing 10. Similarly, the second protruding portion 60 is symmetrically disposed at another corresponding lateral surface 10c of the housing 10.

FIG. 2A is a side view of the protrusion of the portable device in FIG. 1A under normal circumstances. Referring to FIG. 2A, a first clearance is formed by the protrusion 90 and the housing 10, and a first gap X1 exists between the connecting portion 70 and the top surface of the housing 10. As shown in FIG. 2A, the length of the first protruding portion 50 is larger than the first gap X1.

FIG. 2B is a side view of the protrusion of the portable device in FIG. 1A after being rotated for 45°. Referring to FIG. 2B, when the first protruding portion 50 and the second protruding portion 60 rotate with respect to the housing 10 and along an arrow direction for instance, a specific angle such as 45° is contained between the first protruding portion 50 and the housing 10, and a second gap X2 exits between the connecting portion 70 and the housing 10. Referring to both FIGS. 2A and 2B, the clearance formed by the protrusion and the housing becomes larger, and so does the second gap X2 existing between the connecting portion 70 and the housing 10. The second gap X2 is larger than the first gap X1.

FIG. 2C is a side view of the protrusion of the portable device in FIG. 1A after being rotated for 90°. Referring to FIG. 2C, when first protruding portion 50 and the second protruding portion 60 continue to rotate with respect to the housing 10 and along an arrow direction for instance, the first protruding portion 50 forms a specific angle such as 90° with the housing 10. A second clearance is formed by the protrusion 90 and the housing 10, and a third gap X3 exists between the connecting portion 70 and the housing 10. Meanwhile, the protrusion 90 is rotated to the rear surface of the housing 10, the first protruding portion 50 and the second protruding portion 60 are projected from the rear surface of the housing 10. Meanwhile, the third gap X3 exists between the connecting portion 70 and the rear surface of the housing 10. The third gap X3 is larger than the first gap X1. Referring to both FIGS. 2A and 2C, the clearance surrounded by the protrusion 90 and the housing 10 becomes larger, and so does the gap between the connecting portion 70 and the housing 10. Given that the size of the protrusion remains the same, a larger operating space is created between a rotatable protrusion and the housing for the user to make use of. The user is no more subject to the restriction of limited hook space and has more choices with regard to the size and style of hanging decorations for mobile phone. The present embodiment increases product practicality without affecting the size of the device.

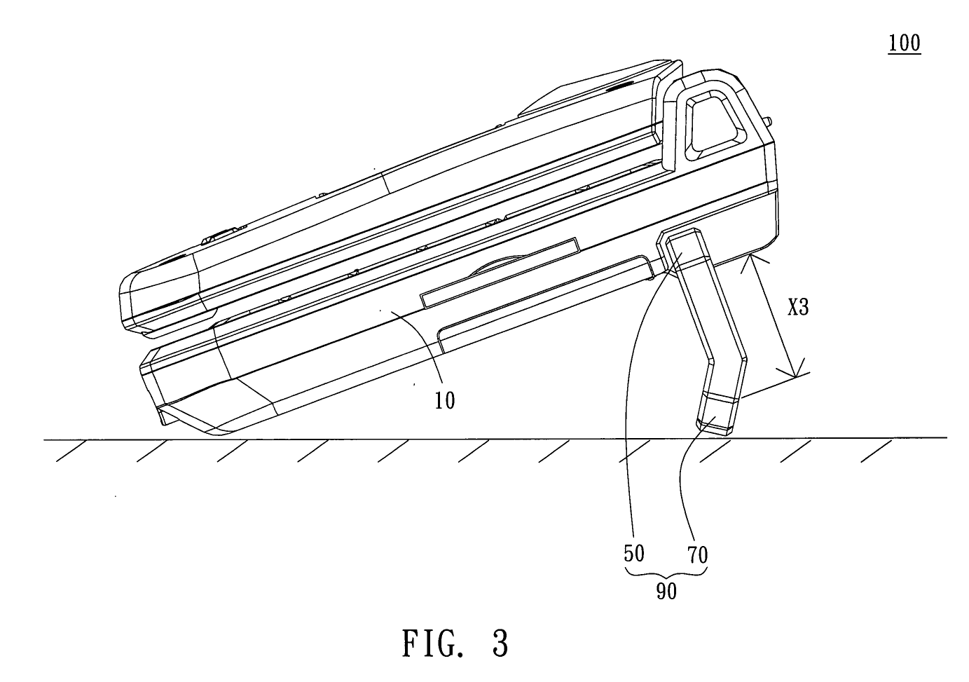

FIG. 3 is a side view of the protrusion of the portable device in FIG. 1A placed on a desk after rotation. When the portable device 100 is placed on a desk, the protrusion 90 is rotatable to the rear surface of the housing 10 to brace the device as shown in FIG. 3. Thus, the portable device 100 tilts a specific angle, facilitating the user to view the display screen more conveniently.

The portable device disclosed in above embodiment of the invention creates a larger operating and hanging space between a rotatable protrusion and the housing, so that the user can reeve a thread through the space to hang a hanging decoration or use the space for other purposes. Product practicality is enhanced without increasing the size of the product. Besides, an antenna module can be received within the protrusion, so the protrusion of the embodiment not only has the antenna function, but also can be used for a hanging decoration for mobile phone to be tied to. On the other hand, when the mobile phone is placed on eth desk, the protrusion is rotated to the rear surface of the housing to brace the device, facilitating the user to view the display screen more conveniently.

The object of the invention is to provide a portable device whose protrusion is pivotally connected to the housing. After the protrusion is rotated, a larger hanging space is created. Therefore, without increasing the size of the mobile phone neither jeopardizing the integral outlook of the device, the restriction on the size of the hanging decoration is lifted, enabling the user to tie various sized hanging decorations for mobile phone.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A portable device, comprising:
a housing; and
a protrusion, comprising:
a first protruding portion which is pivotally connected to the housing, wherein the first protruding portion can rotate with respect to the housing;
a second protruding portion which is pivotally connected to the housing, wherein the second protruding portion can rotate with respect to the housing; and
a connecting portion connecting the first protruding portion and the second protruding portion;
wherein when the first protruding portion and the second protruding portion rotate with respect to the housing, the first protruding portion and second protruding portion are modulated to form a variable angle with the housing.

2. The portable device according to claim 1, wherein the first protruding portion is disposed at a lateral surface of the housing, a part of the first protruding portion is in close proximity of the lateral surface, another part of the first protruding portion extends to the lateral surface and projects from a top surface of the housing, and a first gap exists between the connecting portion and the top surface of the housing.

3. The portable device according to claim 2, wherein the length of the first protruding portion is larger than the first gap.

4. The portable device according to claim 1, when the first and second protruding portions rotate with respect to the housing, the first and second protruding portions project from a rear surface of the housing, and a second gap exists between the connecting portion and the rear surface of the housing.

5. The portable device according to claim 4, wherein the specific angle is substantially 90°.

6. The portable device according to claim 4, wherein the second gap is larger than the first gap.

7. The portable device according to claim 1, wherein the first protruding portion, the second protruding portion and the connecting portion are formed in one-piece molding.

8. The portable device according to claim 1, wherein the protrusion is substantially in the shape of an inverted U.

9. The portable device according to claim 1, wherein the portable device further comprises an antenna module disposed inside the protrusion.

10. The portable device according to claim 1, wherein the portable device comprises a communication module received inside the housing.
